(19) United States
(12) Patent Application Publication
(10) Pub. No.: US 2017/0193847 A1
(43) Pub. Date: Jul. 6, 2017

(54) DYNAMICALLY DEFINED CONTENT FOR A GAMIFICATION NETWORK SYSTEM

(71) Applicant: Callidus Software, Inc., Dublin, CA (US)

(72) Inventors: Anthony J. Ventrice, Loma Mar, CA (US); Sanjeev Chakravarty, Newark, CA (US); Stephen A. Sims, Foster City, CA (US)

(21) Appl. No.: 14/985,910

(22) Filed: Dec. 31, 2015

(51) Int. Cl. G09B 19/00; A63F 13/537; G09B 7/00; G06N 7/00; G09B 5/02

(52) U.S. Cl. CPC G09B 19/00; G06N 7/005; G09B 5/02; G09B 7/00; A63F 13/537

(57) ABSTRACT

The present application describes methods and systems that dynamically define content for use in a gamification network system. Embodiments of the present disclosure include a system that determines a user engagement level for a particular user based at least on stored information regarding a user population including information about past user behavior. The system then modifies the gamification content based at least on the determined user engagement level, the modification being designed to increase the user's engagement level.

### BACKGROUND

To improve efficiency, productivity, and engagement of users many organizations have turned to gamification techniques. Gamification uses game-design elements and game principles in traditionally non-game contexts, such is in employee training and productivity. Gamification strategies can be applied in many contexts, such as health care, financial services, education, physical exercise, transportation, government, employee training, and the like. Gamification techniques can include providing rewards to players who achieve a benchmark or accomplish a task. Further, rewards can be used to foster competition between players to improve engagement.

### BRIEF DESCRIPTION OF THE DRAWINGS

The following description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example of a relationship between a population of users, a particular user, and a gamification network.

FIG. 2 illustrates an example method of the disclosure.

FIG. 3 is a block diagram of an example computing system usable to provide the gamification network system.

FIG. 4 illustrates an example method of the disclosure.

### DESCRIPTION OF THE FIGURES

Embodiments of the present disclosure include a system that dynamically defines content for use in a gamification network system. In embodiments, content can be defined based on information specific to a user. In various embodiments, the system can analyze a particular user's behavior, as well as the behavior of a population of users, to predict the likelihood of certain content resulting in a desired behavior. In further embodiments, the analysis can be used to create new content, such as a new reward, that incentivizes the user to re-engage with the gamification network system.

Gamification network systems are designed to leverage a user's desire for socializing, learning, achieving, status, and competition. Gamification network systems generally include a number of gamification sites. Gamification sites may contain content including goals (e.g., watch a video, answer questions, sell an amount of a product, complete a homework assignment, run a distance, etc.), rewards (e.g., badges, points, levels, etc.), visualizations (e.g., the look and feel of the site, the look of the rewards, the information shown to the user about their progress or the progress of other users, etc.), and milestone logic (e.g., number of points required to achieve a level, number of points required to earn a badge, number of badges required to achieve a level, etc.).

Gamification sites are generally designed to encourage a group of users to achieve a specific goal or a set of related goals. The goals can include a number of tasks that must be completed in order to complete the goal. For example, a goal may require the user to complete five tasks. The goals are generally tied to a reward, such as points, badges, currencies, levels, filling a progress bar, and the like, which indicate that the user is working toward achieving, or has achieved, their goal. As used herein “rewards” includes recognitions.

In a conventional gamification network system, the goals and corresponding rewards are the same for all users of a site, and are created by an administrator of the gamification site. However, in many instances, the traditional model is unable to account for specific situations or personality types of the users, which can lead to a user not being engaged or motivated to achieve the goals. For example, if a user is unable to achieve a goal within a certain period of time, it may be discouraging, and therefore have the opposite of the intended effect. Similarly, if a user is not able to see appreciable progress toward a goal, the user may consider disengaging from the gamification network system because it is not providing subjective value to them.

Embodiments of the present disclosure use prescriptive analytics to create customized content that better engages and motivates a user.

In embodiments, a user may join a gamification network system in which an initial goal and reward is assigned. In various embodiments, the first goal and reward can be standardized for all new users, or a subset of new users. In other embodiments, the first goal and reward can be chosen based on information specific to the new user, such as the age, grade, start date, department, fitness level, indicated interests, financial health, and the like. For example, content, such as a reward, may be created if a user interacts with the gamification network system more than five times within seven days of joining.

In some embodiments, by analyzing the user's progress on the initial goal, as well as the progress of the other users in the gamification network system, the system can create content, such as a second goal and associated reward. The second goal and reward can be assigned to the user upon completion of the initial goal and reward. In other embodiments, the second goal and reward can be assigned before the completion of the first goal and reward. Generally, the aim of the second goal and reward is to maintain the user's engagement level and to motivate the user to achieve the second goal. In some embodiments, the second goal and/or specific subsequent goals may be assigned by a gamification network system administrator and/or by the gamification network system. In various embodiments, the gamification network system does not assign the user a goal until the user's engagement level falls below a threshold level, or the system predicts that the user's engagement level will fall below the threshold level.

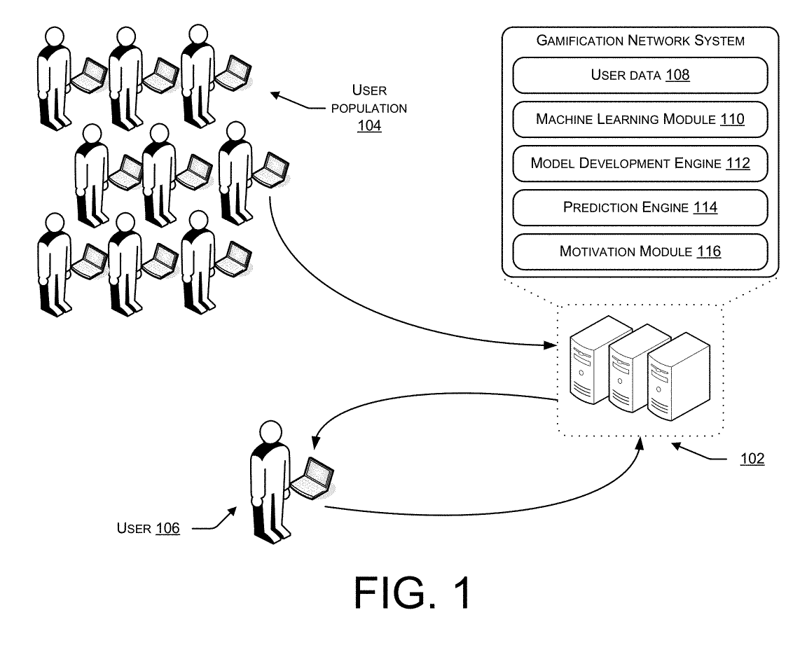

As illustrated in FIG. 1, a gamification network system 102 receives data from user devices operated by users in the user population 104. The data received can include behavioral data, user identification data, user feedback, and the like. The gamification network system 102 can also receive data from a particular user 106. In various embodiments, the particular user 106 is a part of the user population 104. In other embodiments, the particular user 106 is not a part of the user population 104, but may be a part of a second user population.

The user data received by the gamification network system is stored at least in user data 108 and used by the machine learning module 110, which may work with, or be a part of, the model development engine 112. The model development engine 112 creates a model of user behavior. The model can then be used by the prediction engine 114, which may also work with, or include, the machine learning module 110. The prediction engine 114, may use the model created in order to predict a user's future behavior. In some embodiments, the predictions can be related to a user's reaction to a new goal (e.g., increasing or decreasing the level of engagement), or the predictions can be related to the user's future level of engagement given their current goals. In some embodiments, if the prediction engine 114 predicts that a user's engagement level will decrease below a certain level, the prediction engine 114 can communicate with the motivation module 116, which may create new content, such as assigning the user a new goal, which is designed to increase the user's engagement level. The motivation module 116 may also associate a reward with a new goal. A chosen reward may also be designed to increase the user's engagement level.

In some embodiments, the motivation module 116 may create new content, such as assigning a new goal and accompanying reward, for the user 106 and the user population 104 as a whole. In other embodiments, the motivation module 116 may create new content, such as assigning a new goal and accompanying reward, for subset(s) of the user population, one of which includes the user 106, in which, for example, the subset(s) of the user population work as a team.

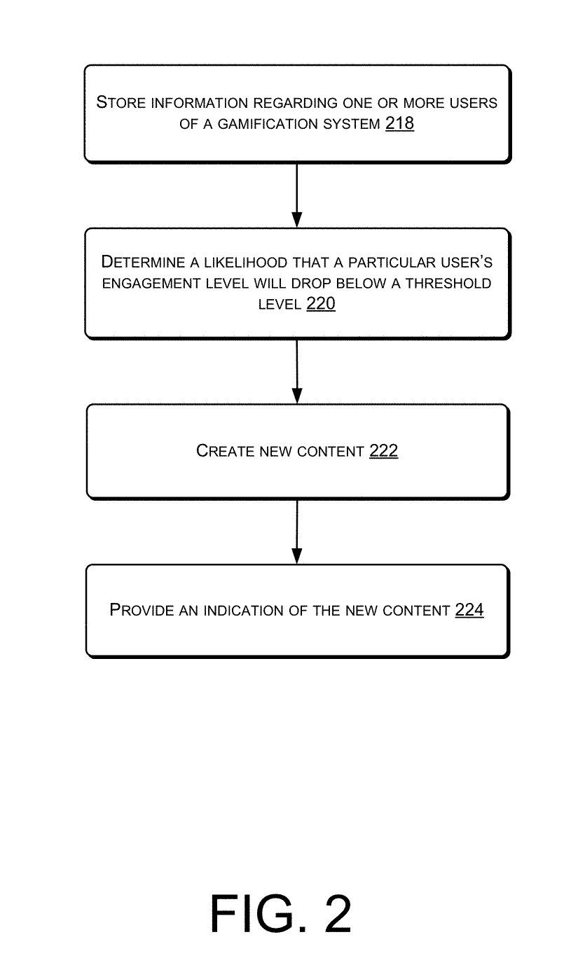

An illustrative method of the disclosure is shown in FIG. 2. Information regarding one or more users of a gamification network system is stored, as shown in 218. In various embodiments the information can include identifying user data, such as a username, an anonymized tag, etc.; user behavior data, such as frequency of interaction with the gamification site, amount of time used to complete a task, types of tasks completed, order of tasks completed, device used to complete a task (e.g., cellular phone, tablet, personal computer (PC), etc.), rewards associated with completing a given task, tasks that remain uncompleted, and the like; and user feedback, including specific feedback about tasks, goals, rewards, etc. that have been previously completed or have been left incomplete.

The system then determines a likelihood that a particular user's engagement level will drop below a threshold level 220. In other embodiments, the system determines the particular user's engagement level without calculating a likelihood that the user's engagement level will drop below the threshold level. In embodiments, the particular user's engagement level is determined using a model of the user's past and/or current behavior. In some embodiments, the particular user's engagement level is determined in part by comparing the user to other users in the user population. For example, the system may determine that a user is 50% less productive than the average user of the gamification network system.

In embodiments, the particular user's engagement level can be compared to a threshold level. In some embodiments, the threshold level is the same for all users, or for a subset of users. In other embodiments, the threshold level is individually determined for each user.

The gamification network system then creates new content, as shown at 222. In some embodiments, a current goal or reward is changed. In some embodiments, a new goal and accompanying reward is selected. In such embodiments, the goal is selected in order to increase the likelihood that the user will increase their engagement with the gamification network system. In embodiments, the goal may be selected based on the user's past and/or current behavior. For example, if a user always waits at least one week to attempt to play a mini-game to win points, but never waits more than a day to watch a video to win points, the system may select a new goal of watching two videos in order to encourage user engagement. In some embodiments, the selection of the goal may also be based at least in part on user feedback. For example, if the user previously has provided feedback that they strongly dislike watching videos in order to earn points, but strongly like playing a mini-game to earn points, the goal selected might be to win or to achieve a certain level in a mini-game in order to encourage user engagement. Other examples are possible without departing from the scope of embodiments.

Similarly, the gamification network system can also select a reward associated with the new goal for the user. In embodiments, the reward may be selected based on the user's past and/or current behavior. For example, if a user always waits at least one week to attempt to complete a goal that has a reward of 10 points, but never waits more than a day to attempt to complete a goal that has a reward of a badge, the system may select a badge as the new reward in order to encourage user engagement. In some embodiments, the selection of the goal may also be based at least in part on user feedback. For example, if the user previously has provided feedback that they strongly dislike earning badges, but strongly like leveling-up, the reward selected might be associated with an increase in the user's level. Other examples are possible without departing from the scope of embodiments.

In other embodiments, the new content may be a new visualization. For example, a leaderboard may be created such that the particular user may be able to see the progress of other users in the user population. Other examples are possible without departing from the scope of embodiments.

In further embodiments, the new content may be a change in milestone logic. In some embodiments, the change in milestone logic may indicate a specified amount of time. For example, achieving a new level may normally require a user to earn 10 points and two badges, but the user may be able to achieve a new level if they earn 5 points and two badges in the next week. Other examples are possible without departing from the scope of embodiments.

In some embodiments, the new content is directed to the particular user. In other embodiments, the new content is directed to the user population or subset(s) of the user population, including the particular user.

In embodiments, the gamification network system provides an indication of the new content, as shown in 224. For example, the gamification network system can provide an indication of a new goal and accompanying reward to a particular user. In other embodiments, the gamification network system provides an indication of the goal. In further embodiments, the gamification network system provides an indication of the reward. The indication can be provided to the particular user, as well as any other users that may be affected by the new content. For example, if the new content is directed at the user population as a whole, the indication may be provided to the entire user population as well.

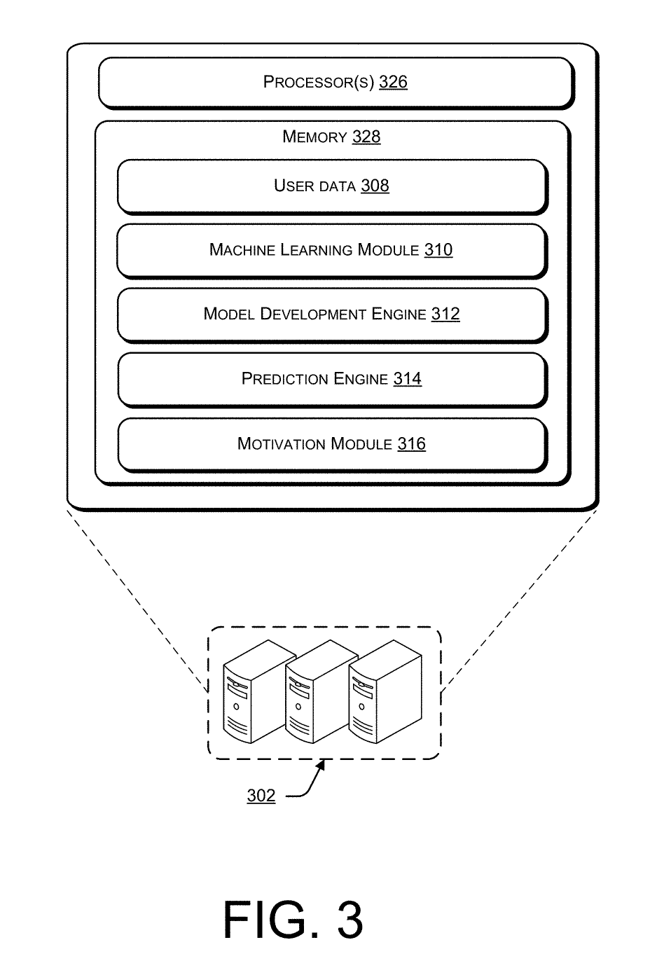

FIG. 3 is a block diagram of an example computing system usable to provide the gamification network system described herein. The gamification network system 302 may be configured as any suitable computing device or computing devices capable of performing the operations described herein. Suitable computing devices may include or be part of PCs, servers, server farms, datacenters, special purpose computers, combinations of these, or any other computing device(s).

In some embodiments, the gamification network system 302 includes processor(s) 326. The processor(s) 326 are central processing unit(s) (CPU) or other processing unit(s). Individual ones of the processor(s) 326 may include a circuit device having transistor circuits arranged in semiconductor substrate to perform arithmetic, logical, and/or input/output (I/O) operations. The circuit device may be configured to execute these operations according to an instruction set, the instruction set defining machine codes (e.g., operational codes) that cause the transistor circuits to perform operations responsive to the associated machine codes being copied to an instruction register(s) of the processor(s) 326.

In various embodiments, the processor(s) 326 are further communicatively coupled to memory 328. Memory 328 can include volatile and nonvolatile, removable and non-removable media implemented in any method or technology for storage of information, such as computer readable instructions, data structures, program modules, or other data. Depending on the configuration and type of computing device used, memory 328 may include volatile memory (such as random access memory (RAM)) and/or non-volatile memory (such as read-only memory (ROM), flash memory, etc.). Generally, memory 328 includes both volatile memory and non-volatile memory (e.g., RAM, ROM, EEPROM, Flash Memory, miniature hard drive, memory card, optical storage, magnetic cassettes, magnetic tape, magnetic disk storage or other magnetic storage devices, or any other medium). Memory 328 may also include additional removable storage and/or non-removable storage including flash memory, magnetic storage, optical storage, and/or tape storage that may provide non-volatile storage of computer-readable instructions, data structures, program modules, and other data.

Memory 328 is an example of computer-readable media. Computer-readable media includes at least two types of computer-readable media, namely computer storage media and communications media.

Computer storage media includes volatile and non-volatile, removable and non-removable media implemented in any process or technology for storage of information such as computer-readable instructions, data structures, program modules, or other data. Computer storage media includes phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

Communication media may embody computer-readable instructions, data structures, program modules, or other data in a modulated data signal, such as a carrier wave, or other transmission mechanism. As used herein, computer storage media does not include communication media.

The memory 328 stores data 308 and modules 310-316. Memory 328 may store program instructions that are loadable and executable on the processor(s) 326, as well as data generated during execution of, and/or usable in conjunction with, these programs. For example, the memory 328 includes the user data 308, machine learning module 310, model development engine 312, prediction engine 314, and motivation module 316.

In various embodiments, the memory 328 stores user data 308. In such embodiments, user data 308 can include identifying information about a user (e.g. username, authentication credentials, indicated preferences, start date, job title, tenure, attendance records, payroll, bonus information, and the like), behavioral information (e.g., time taken to complete a task, types of tasks completed, the order in which tasks were completed, interactions between users, etc.), and/or user feedback. User data 308 can also include data regarding the user's association with a particular site or network. Further, the user data 308 can include associations between users, such as a supervisor-supervisee relationship, peers, and the like.

In embodiments, a machine learning module 310 that is programmed to be operated by the processor(s) 326 may be present. The machine learning module 310 may comprise any number of sub-modules, applications, threads, or processes and may include stored data associated with the machine learning module 310. The machine learning module 310 may include stored user data or may use data stored in the user data 308. For example, the machine learning module 310 may store information about the user, behavioral information, and/or user feedback.

In some embodiments, the machine learning module 310 includes algorithms that utilize the stored user data or user data 308 to learn from and predict user behavior, such as user engagement. Any suitable machine learning approach can be used by the machine learning module 310, such as decision tree learning, association rule learning, artificial neural networks, inductive logic programming, support vector machines, clustering, Bayesian networks, reinforcement learning, representation learning, similarity and metric learning, sparse dictionary learning, and/or genetic algorithms.

In embodiments, a model development engine 312 that is programmed to be operated by the processor(s) 326 may be present. The model development engine 312 may comprise any number of sub-modules, applications, threads, or processes and may include stored data associated with the model development engine 312. In some embodiments, the model development engine 312 works with the machine learning module 310 in order to create a model of a user's behavior. In some embodiments, the model development engine 312 may include one or more models created by the machine learning module 310. In various embodiments, the machine learning module 310 may be a part of the model development engine 312.

In embodiments, the machine learning module 310 and/or the model development engine 312 determines correlations between user data and outcomes in order to predict future outcomes based on the determined correlations. Such correlations may include correlations of a user's past behavior and disengagement from the gamification network system, correlations between content of the gamification network system and user engagement level, correlations between the content of the gamification network system and the user's past behavior, and the like. In some embodiments, the machine learning module 310 and/or the model development engine 312 identifies the strength of the correlation between user data and an outcome.

For example, the correlation between the probability of disengagement, the length of time since the last interaction with the gamification network system, and the user's achievement level (e.g., level three fire dragon), can be represented using a weighted sum. In this example, an equation such as P=Ax+By could be used, where P is the probability of disengagement, x is the length of time since the user's last interaction with the system, y is the user's achievement level, and A and B are constants calculated by the machine learning module 310 and/or the model development engine 312 based on past behavior data from the user population, or a subset of the user population.

In various embodiments, the model development engine 312 may monitor a user's behavioral data, such as a user's engagement level, and provide feedback to the machine learning module 310 in order to further refine the model of the user's behavior. In other embodiments, the model development engine 312 may monitor a user's behavioral data, such as a user's engagement level, and further refine the model of the user's behavior stored in the model development engine 312.

In some embodiments, the model development engine 312 can assess previously-assigned goals and rewards for effectiveness. The model development engine 312 may consider the amount of time before the user began to work toward completing the goal or task(s) associated with the goal, the amount of time needed to complete the goal or task(s) associated with the goal, the number of failed attempts to complete the goal or task(s) associated with the goal, user feedback regarding the goal or task(s) associated with the goal, and the like. The model development engine 312 may also take into account user information such as an attendance record. For example, if a user was absent from work for three days, that time may be subtracted from the total amount of time needed to complete a goal or a task associated with the goal. In further embodiments, the model development engine 312 may consider payroll or bonus information, as that may also have an impact on the user's engagement level, which may skew the model. The prediction engine 314 and/or motivation module 316 can use such an assessment in determining the likely user response to a new motivational action (e.g., goal, reward, and the like).

In embodiments, a prediction engine 314 that is programmed to be operated by the processor(s) 326 may be present. The prediction engine 314 may comprise any number of sub-modules, applications, threads, or processes and may include stored data associated with the prediction engine 314. In some embodiments, the prediction engine 314 uses the model of user behavior, such as the one stored in the model development engine 312, in order to predict a user's behavior in the future. In embodiments, the machine learning module 310 may be a part of the prediction engine 314. In other embodiments, the prediction engine 314 works with the machine learning module 310 in order to predict the user's behavior. In embodiments, the prediction engine 314 predicts the impact on a user's motivation level of one or more potential goal(s), reward(s), and/or other motivational action(s). The potential goal(s), reward(s), and/or other motivational action(s) may be may be chosen by the prediction engine 314, the model development engine 312, and/or the motivation module 316.

In embodiments, a motivation module 316 that is programmed to be operated by the processor(s) 326 may be present. The motivation module 316 may comprise any number of sub-modules, applications, threads, or processes and may include stored data associated with the motivation module 316. The motivation module 316 creates new content, such as goals, rewards, visualizations, milestone logic and other motivational actions. In embodiments, the motivation module may be programmed to provide a user with a goal. In some embodiments, the motivation module may also track the progress of a user toward a goal. In embodiments, the motivation module 316 provides user data regarding the user's behavior to be stored in user data 308. The motivation module 316 may also select a reward associated with a goal.

In embodiments, the motivation module 316 may take actions to motivate a user other than assigning a new goal and/or reward. For example, the model development engine 312 may indicate that a user is more likely to be motivated by negative reinforcement, such as a demotion in level, loss of points, etc., rather than by positive reinforcement. In such cases, the motivation module 316 may select a motivational action, such as a demotion in level, if the user does not complete the currently assigned goal by a certain time, in order to increase the user's engagement.

In some embodiments, the motivation module 316 may change the visualizations of a gamification network system. For example, the motivation module 316 may change the look of a badge, add a progress bar, and the like.

In embodiments, the motivation module 316 may change the milestone logic of a gamification network system. For example, the motivation module 316 may change the number of points required to achieve the next level, the number of points to achieve a badge, and the like. In some embodiments, such changes may be implemented on a temporary basis. For example, a badge may normally require a user to earn 15 points, but the user may be able to earn a badge if they earn 10 points in the next hour.

In embodiments, the motivation module 316 create new content based on user data 308. For example, the motivation module 316 may receive information regarding the date on which a user joined a gamification network system 302. The motivation module 316 may then create a reward for the user if the user interacts with the gamification network system more than 10 times within the first month.

In embodiments, the motivation module 316 create new content in the form of a change in milestone logic based on user data 308. For example, gamification network system 302 may be used in a school, and the motivation module 316 may receive information regarding a new student. If the student is placed in the second grade, the motivation module 316 may assign a goal of reading 10 pages per week. If the student is then moved to the third grade, the motivation module 316 may update the goal to reading 25 pages per week. In yet another example, a user with the job title “inventory clerk” and may have a goal to watch five videos over a two-week span. If the user is then promoted to “director of inventory,” the motivation module 316 may change the goal to watching five videos over a three-week span.

In further embodiments, the motivation module 316 may change the content of the gamification network system for a population of users in order to increase one or more users' engagement levels. For example, a motivation module 316 may not update a leader board until a specific date in order to foster competition. In another example, the motivation module 316 may implement a motivational action for a user population in order to encourage an increase in overall user engagement levels. In a further example, the motivation module 316 may implement a new motivational action which requires subset(s) of the user population to work as a team. In such an example, the user would not only be incentivized to achieve the goal for personal benefit, but also in order to benefit the team, therefore increasing the user's engagement level.

In some embodiments, the prediction engine 314 may predict that a user's engagement will fall below a threshold value based at least in part on the model of the user's behavior in the model development engine 312. If the prediction engine 314 makes such a prediction, it may send an indication to the motivation module 316, which causes the motivation module 316 to create new content, for example, assigning a new goal to the user or changing an existing goal. In embodiments, the content created (e.g., a new goal, a reward, a visualization, etc., or a change in a goal, reward, visualization, etc.) may be chosen based at least on the likelihood of increasing the user's engagement. In further embodiments, the likelihood of increasing the user's engagement may be determined by the user's past behavior data and/or by feedback provided by the user. In some embodiments, the specific requirements of the new content may be determined by the motivation module 316. In other embodiments, the specific requirements of the new content may be determined by the motivation module 316 and the machine learning module 310.

In some embodiments, the model development engine 312 and/or the prediction engine 314 may identify a user who has an engagement level that has fallen below a threshold value. If the prediction engine 314 makes such a prediction, it may cause the motivation module 316 create new content, such as assigning a new goal to the user, changing an existing goal, or to implementing another motivational action. In some embodiments, the specific requirements of the changed or new content may be determined by the motivation module 316 and/or the machine learning module 310.

In embodiments, the specific requirements of portions of the new content may be determined by the motivation module 316, the prediction engine 314, the model development engine 312, and/or the machine learning module 310, while the specific requirements of other portions of the new content may be determined by another of the motivation module 316, the prediction engine 314, the model development engine 312, and/or the machine learning module 310.

In some embodiments, the motivation module 316 may receive an indication from the user data 308, which causes the motivation module 316 to create new content, for example, assigning a new goal to the user or changing an existing goal. The indication from the user data 308 may be, for example, information regarding the date on which the user joined the gamification network system, a change in grade, title, user interests, or pay scale, and the like. In embodiments, the content created (e.g., a new goal, a reward, a visualization, etc., or a change in a goal, reward, visualization, etc.) may be chosen based at least on the likelihood of increasing the user's engagement. In further embodiments, the likelihood of increasing the user's engagement may be determined by the user's past behavior data and/or by feedback provided by the user. In some embodiments, the specific requirements of the new content may be determined by the motivation module 316. In other embodiments, the specific requirements of the new content may be determined by the motivation module 316 and/or the machine learning module 310.

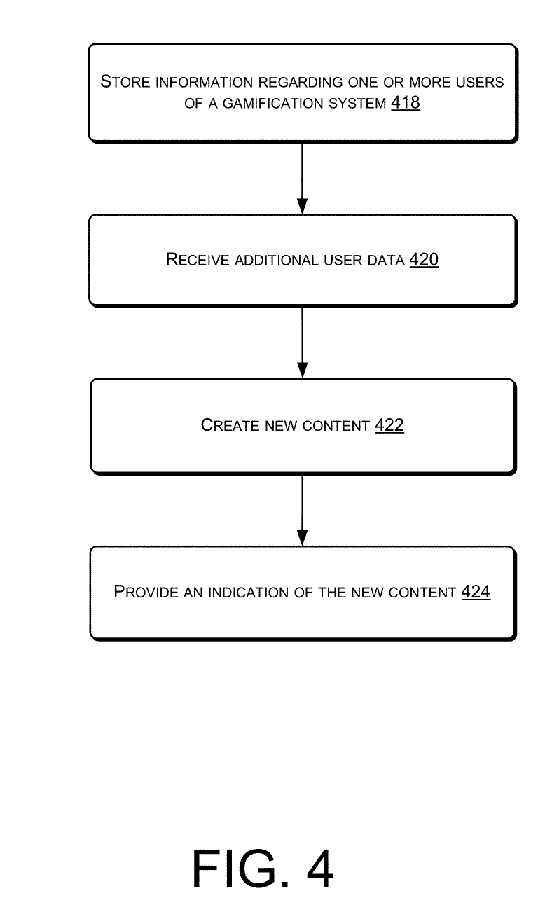

An illustrative method of the disclosure is shown in FIG. 4. Information regarding one or more users of a gamification network system is stored, as shown in 418. In various embodiments the information can include identifying user data, such as a username, an anonymized tag, job title, grade level, pay scale, etc.; user behavior data, such as frequency of interaction with the gamification site, amount of time used to complete a task, types of tasks completed, order of tasks completed, device used to complete a task (e.g., cellular phone, tablet, personal computer (PC), etc.), rewards associated with completing a given task, tasks that remain uncompleted, and the like; and user feedback, including specific feedback about tasks, goals, rewards, etc. that have been previously completed or have been left incomplete.

Additional user data is received at 420. In embodiments, the additional user data may be related to a new user or to an existing user of the gamification network system. In some embodiments, this user data may relate to a user that has joined the gamification network system (e.g., start date, job title, etc.). In some embodiments, this user data may relate to a change in user data (e.g., grade level, job title, etc.).

At least partially in response to receiving user data, the gamification network system then creates new content, as shown at 422. In some embodiments, the new content may be a change in milestone logic. For example, a user may be a salesperson and may have previously had a goal of selling six cars in a month. If the user is then promoted to manager, their goal may be lowered to selling four cars within the month. In some embodiments, the change in milestone logic may indicate a specified amount of time. Other examples are possible without departing from the scope of embodiments.

In some embodiments, a new goal and accompanying reward is selected. In such embodiments, the goal may be selected in order to increase the user's engagement with the gamification network system. In embodiments, the goal may be selected based on the user's past and/or current behavior. Similarly, the gamification network system can also select a reward. For example, a user may join a gamification network system, and if they interact with the system at least every other day over the course of a month, they may be provided with a reward. In some embodiments, the reward is associated with the new goal for the user. In embodiments, the reward may be selected based on the user's past and/or current behavior. Other examples are possible without departing from the scope of embodiments.

In other embodiments, the new content may be a new visualization. For example, a leaderboard may be created such that the particular user may be able to see the progress of other users in the user population. Other examples are possible without departing from the scope of embodiments.

In some embodiments, the new content is directed to the particular user. In other embodiments, the new content is directed to the user population or subset(s) of the user population, including the particular user. For example, if the user data received is related to an employee leaving a company, the goals of the remaining employees in that company or in a specific department may be raised or lowered in order to accommodate the additional workflow.

In embodiments, the gamification network system provides an indication of the new content, as shown in 424. For example, the gamification network system can provide an indication of the changed goal and/or reward. In other examples, the gamification network system can provide an indication of a new goal and accompanying reward to a particular user. In other embodiments, the gamification network system provides an indication of the goal. In further embodiments, the gamification network system provides an indication of the reward. The indication can be provided to the particular user, as well as any other users that may be affected by the new content. For example, if the new content is directed at the user population as a whole, the indication may be provided to the entire user population as well.

Although the disclosure uses language that is specific to structural features and/or methodological acts, the invention is not limited to the specific features or acts described. Rather, the specific features and acts are disclosed as illustrative forms of implementing the invention.

We claim:

1. A computing system, comprising:
one or more processors; and
a memory coupled to the one or more processors, the memory storing computer-executable instructions that, when executed by the one or more processors, cause the one or more processors to:
store information regarding one or more users of a gamification network system including information regarding a past behavior of a particular user of the one or more users;
determine, using at least the information regarding the one or more users, a likelihood that the particular user is going to disengage with the gamification network system; and
modify, based at least on the determining the likelihood that the particular user is going to disengage with the gamification network system, a content of the gamification network system that is associated with the particular user.

2. The computing system of claim 1, wherein the content is a goal, a reward, a visualization, or an aspect of milestone logic.

3. The computing system of claim 1, wherein the computer-executable instructions, when executed by the one or more processors, further cause the one or more processors to provide an indication of the content to the particular user.

4. The computing system of claim 1, wherein the modifying the content of the gamification network system is based at least in part on the past behavior of the particular user.

5. The computing system of claim 1, wherein the modifying the content of the gamification network system is based at least in part on the information regarding one or more users of the gamification network system.

6. The computing system of claim 5, wherein the information regarding one or more users of the gamification network system includes information regarding past behaviors of a subset of the one or more users of the gamification network system, the subset of the one or more users being demographically similar to the particular user.

7. The computing system of claim 1, wherein the computer-executable instructions, when executed by the one or more processors, further cause the one or more processors to compare the likelihood that the particular user is going to disengage from the gamification network system to a threshold value.

8. The computing system of claim 7, wherein the modifying the content is based at least in part on the comparing the likelihood that the particular user is going to disengage from the gamification network system to a threshold value.

9. A computing system, comprising:
one or more processors; and
a memory coupled to the one or more processors, the memory storing computer-executable instructions that, when executed by the one or more processors, cause the one or more processors to:
store information regarding one or more users of a gamification network system including information regarding one or more past behaviors of the one or more users;
determine, using at least the information regarding the one or more users, a user engagement level for a particular user of the one or more users; and
modify, based at least on determining the user engagement level for the particular user, a content of the gamification network system that is associated with the particular user.

10. The computing system of claim 9, wherein the content is a goal, a reward, a visualization, or an aspect of milestone logic.

11. The computing system of claim 9, wherein the computer-executable instructions, when executed by the one or more processors, further cause the one or more processors to provide an indication of the content to the particular user.

12. The computing system of claim 9, wherein the modifying the content of the gamification network system is based at least in part on a past behavior of the particular user.

13. The computing system of claim 9, wherein the modifying the content of the gamification network system is based at least in part on information regarding one or more past behaviors of a subset of the one or more users, the subset of the one or more users being demographically similar to the particular user.

14. The computing system of claim 9, wherein the computer-executable instructions, when executed by the one or more processors, further cause the one or more processors to compare the user engagement level for the particular user to a threshold value.

15. The computing system of claim 14, wherein the modifying the content of the gamification network system is based at least in part on the comparing the user engagement level for the particular user to a threshold value.

16. A method comprising:
receiving, by a computing system, information regarding a user of a gamification network system; and
modifying, by the computing system, the content of the gamification network system that is associated with the user to create a modified content, based at least on receiving the information regarding the user.

17. The method of claim 16, wherein the modified content is a goal, a reward, a visualization, or an aspect of milestone logic.

18. The method of claim 16, further comprising providing, by the computing system, an indication of the modified content to the user.

19. The method of claim 16, wherein the computing system stores information regarding one or more past behaviors of the user, and wherein the modifying the content of the gamification network system is based at least in part on the information regarding one or more past behaviors of the user.

20. The method of claim 16, wherein the computing system stores information regarding one or more users of the gamification network system, and wherein the modifying the content of the gamification network system is based at least in part on the information regarding the one or more users.
